(19) United States
(12) Patent Application Publication
(10) Pub. No.: US 2023/0107567 A1
(43) Pub. Date: Apr. 6, 2023

(54) DEVICE AND METHOD FOR MEASURING DISTANCE BY TIME OF FLIGHT

(71) Applicant: Ningbo ABAX Sensing Co., Ltd., Ningbo City (CN)

(72) Inventor: Shuyu LEI, Ningbo City, Zhejiang Province (CN)

(73) Assignee: Ningbo ABAX Sensing y Co., Ltd., Ningbo City (CN)

(21) Appl. No.: 17/911,516

(22) PCT Filed: Dec. 18, 2020
(86) PCT No.: PCT/CN2020/137576

§ 371 Date: Sep. 14, 2022

(30) Foreign Application Priority Data
Mar. 16, 2020 (CN) 202010179897.4
Sep. 28, 2020 (CN) 202011040936.9

(51) Int. Cl. G01S 7/48; G01S 17/10; G01S 7/4863; G01S 7/4865

(52) U.S. Cl. CPC G01S 7/4802; G01S 17/10; G01S 7/4863; G01S 7/4865

(57) ABSTRACT

Disclosed are a device and method for measuring distance by time of flight. The device includes a light-emitting module (110), a processing module (120) and a light receiving module (130), wherein the light-emitting module (110) comprises at least two emitting regions, and the light receiving module (130) comprises at least two receiving regions corresponding to the light-emitting module (110); the processing module (120) can generate a first instruction for electrical connection to all emitting units so that same output emitted light at the same time, all receiving units of the light receiving module (130) are in one-to-one correspondence with the emitting units; and the processing module (120) carries out calculation, according to data from the light receiving module (130), to obtain detected target distance data. The processing module (120) can further generate an instruction different from the first instruction, for the light emitting module (110) to output the emitted light once or more than once; the light receiving module (130) obtains reflected light information of a target region once or more than once, and a result of at least one of the pieces of reflected light information of the target region obtained by the light receiving module (130) does not comprise multi-path reflected light information; and the processing module (120) carries out calculation to obtain target distance data that at least does not comprise part of the multi-path reflected light information, such that a detection result adapted to a view field scene is obtained, and distance data after multipath weakening or elimination can be obtained according to different instruction

### CROSS REFERENCE TO RELATED APPLICATIONS

The present application claims priority to Chinese Patent Application No. 202011040936.9, titled “DEVICE AND METHOD FOR MEASURING DISTANCE BY TIME OF FLIGHT”, filed on Sep. 28, 2020 with the Chinese Patent Office, which is incorporated herein by reference in its entirety.

The present application claims priority to Chinese Patent Application No. 202010179897.4, entitled “DETECTION DEVICE AND METHOD” filed on Mar. 16, 2020 with the Chinese Patent Office, which is incorporated herein by reference in its entirety.

### FIELD

The present disclosure relates to the technical field of time-of-light distance measurement, and in particular to a time-of-flight distance measurement device and a time-of-flight distance measurement method.

### BACKGROUND

The time-of-flight (TOF) technology has been developed as a method for measuring a distance to a target in a scene. The TOF technology can be applied in various fields, such as automotive industries, human-machine interfaces, games, and robotics. The TOF technology is generally achieved by the following processes. A scene is illuminated with modulated light emitted from a light source, and the reflected light reflected from the target in the scene is observed. A phase difference between the emitted light and the reflected light is measured to calculate the distance to the target.

In a conventional distance measurement device using the TOF technology, multipath interference may affect the accuracy of the measured distance. The multipath interference occurs in a case that the emitted light travels along multiple paths having different path lengths, where the multiple paths of light are sensed by a single light receiver as integrated light. Although the phases of light along the different path lengths are different from each other, the conventional distance measurement device calculates the distance based on the mixed phase of the integrated light. In this case, the calculated distance may contain an error caused due to the multipath interference.

In the conventional technology, a technique for detecting the multipath error based on the exposure amount of the light receiver is proposed. Further, in the conventional technology, a light emitter emits light that illuminates a given region. The region is divided into multiple sub-regions, and the controller is configured to control the light emitter to change the amount of light emitted to each sub-region, so as to emit in different light emission modes at different times. The controller calculates the exposure amount received at the light receiver of each sub-region, and detects the multipath error based on the calculated exposure amount. Specifically, the controller calculates the exposure amount at the light receiver in a first emission mode at a first timing sequence, and the controller calculates the exposure amount at the light receiver in a second emission mode at a second timing sequence. Based on a difference between the exposure amount calculated at the first timing sequence and the exposure amount calculated at the second timing sequence, the controller determines whether the multipath error occurs.

However, in the conventional technology, the exposure amount is required to be calculated in two different light emission modes (i.e., at the first timing sequence and the second timing sequence) in order to detect the multipath error. Therefore, according to the method in the conventional technology, a time delay is inevitably generated due to the sequential calculation of the exposure amount. Due to the time delay, the detection accuracy of the multipath error may be decreased. For example, if the multipath interference occurs during the first timing sequence but is resolved before the second timing sequence, the controller may not be able to detect the multipath error correctly, which may affect the accuracy of the calculated distance to the target. Further, in the detection process, it is required to perform switching between different detection modes to adapt different detection scenarios, thus completing the adaptive design for the different scenarios. In addition, the obtained distance data in the detection process is required to be accurate. Therefore, it is urgent to propose a solution that can adapt to the needs of the scene and can reduce or even eliminate the multipath interference.

### SUMMARY

In view of the above, an object of the present disclosure is to provide a time-of-flight distance measurement device and a time-of-flight distance measurement method, to solve technical problems in the conventional technology such as poor accuracy of the measured distance.

In order to achieve the above object, solutions in the embodiments of the present disclosure are provided.

In a first aspect, a time-of-flight distance measurement device is provide according to an embodiment of the present disclosure. The device includes: a light emitting module, a processing module and a light receiving module. The light emitting module has at least two emitting regions, and the light receiving module has at least two receiving regions corresponding to the light emitting module. The processing module is configured to generate a first instruction to be electrically connected to all emitting units so that all the emitting units simultaneously output emitted light, where receiving units of the light receiving module are in one-to-one correspondence with the emitting units, and the processing module is configured to calculate distance data of a detected target according to data of the light receiving module. The processing module is further configured to generate an instruction different from the first instruction, so that the light emitting module outputs the emitted light once or more than once, where the light receiving module acquires reflected light information of a target region once or more than once, and a result in the reflected light information of the target region that is obtained by the light receiving module at least once does not contain multipath reflected light information, and the processing module is configured to calculate target distance data that at least does not contain a part of the multipath reflected light information.

Optionally, the first instruction is related to a distance to the detected target in a field of view, a reflectivity of the detected target in the field of view, historical detection distance information, or the like.

Optionally, the processing module further includes: a control module configured to control the receiving region corresponding to the emitting region to receive the reflected light.

Optionally, the at least two emitting regions are in one-to-one correspondence with the at least two receiving regions.

Optionally, the control module is configured to control one or more of the emitting regions to emit light to a designated region.

Optionally, the control module is configured to control a receiving region among the receiving regions corresponding to the one or more emitting regions emitting the light to the designated region to receive the reflected light.

Optionally, the emitting region has a conjugate relationship with the corresponding receiving region.

Optionally, the receiving regions include a region that receives the reflected light from a to-be-detected target and/or a region that receives the multipath reflected light.

Optionally, the control module is electrically connected to the emitting module and is configured to control the emitting region to emit light to a designated region.

Optionally, the control module is electrically connected to the receiving module and is configured to control the receiving region that does not have a corresponding relationship with the emitting region to receive multipath light.

Optionally, the control module is electrically connected to the receiving module and is configured to control the receiving region that does not have a corresponding relationship with the emitting region to not receive the reflected light.

Optionally, the processing module further includes: an information acquiring unit configured to: according to the reflected light information that does not contain at least a part of the multipath and that is outputted by the receiving module in at least a part of the time period.

Optionally, in the case of the instruction different from the first instruction, the light emitting module outputs the emitted light more than once, the light receiving module acquires the reflected light information of the target region more than once, and the processing module synthesizes all information of a detected field of view according to the reflected light information of the target region acquired by the light receiving module more than once.

In a second aspect, a time-of-flight distance measurement method is provided according to an embodiment of the present disclosure. The method includes: a light emitting module, a processing module and a light receiving module, where the light emitting module has at least two emitting regions, and the light receiving module has at least two receiving regions corresponding to the light emitting module. The processing module is capable of generating a first instruction to be electrically connected to all emitting units so that all the emitting units simultaneously output emitted light, where receiving units of the light receiving module are in one-to-one correspondence with the emitting units, and the processing module calculates distance data of a detected target according to data of the light receiving module. The processing module is further capable of generating an instruction different from the first instruction, so that the light emitting module outputs the emitted light once or more than once, where the light receiving module acquires reflected light information of a target region once or more than once, and a result in the reflected light information of the target region that is obtained by the light receiving module at least once does not contain multipath reflected light information, and the processing module is configured to calculate target distance data that at least does not contain a part of the multipath reflected light information.

Optionally, the first instruction is related to a distance to the detected target in a field of view, a reflectivity of the detected target in the field of view, historical detection distance information, or the like.

Optionally, the processing module further includes: a control module configured to control the receiving region corresponding to the emitting region to receive the reflected light.

Optionally, the at least two emitting regions are in one-to-one correspondence with the at least two receiving regions.

Optionally, the control module controls one or more of the emitting regions to emit light to a designated region, and the control module controls a receiving region among the receiving regions corresponding to the one or more emitting regions emitting the light to the designated region to receive the reflected light.

Optionally, the receiving regions include a region that receives the reflected light from a to-be-detected target and/or a region that receives the multipath reflected light.

Optionally, the control module is electrically connected to the receiving module and controls the receiving region that does not have a corresponding relationship with the emitting region to receive multipath light.

The present disclosure has the following beneficial effects.

A time-of-flight distance measurement device and a time-of-flight distance measurement method are provided according to embodiments of the present disclosure. The time-of-flight distance measurement device includes: a light emitting module, a processing module and a light receiving module. The light emitting module has at least two emitting regions, and the light receiving module has at least two receiving regions corresponding to the light emitting module. The processing module is configured to generate a first instruction to be electrically connected to all emitting units so that all the emitting units simultaneously output emitted light, where receiving units of the light receiving module are in one-to-one correspondence with the emitting units, and the processing module is configured to calculate distance data of a detected target according to data of the light receiving module. The processing module is further configured to generate an instruction different from the first instruction, so that the light emitting module outputs the emitted light once or more than once, where the light receiving module acquires reflected light information of a target region once or more than once, and a result in the reflected light information of the target region that is obtained by the light receiving module at least once does not contain multipath reflected light information, and the processing module is configured to calculate target distance data that at least does not contain a part of the multipath reflected light information. With the time-of-flight distance measurement device provided in the present disclosure, the influence of the multipath can be weakened or eliminated in a specific scenario, and a complex detection scenario can be applied, achieving the effect of accurate detection, and ensuring the intelligence of the whole device.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagrams showing functional modules for existing TOF distance measurement according to an embodiment of the present disclosure;

FIG. 2 is another schematic diagram showing functional modules for existing TOF distance measurement according to an embodiment of the present disclosure;

FIG. 3 is a schematic diagram showing a multipath scenario in the time-of-flight distance measurement in the conventional technology;

FIG. 4 is a schematic diagram showing an influence of the multipath on measurement accuracy in the conventional technology according to an embodiment of the present disclosure;

FIG. 5 is a schematic diagram showing a conjugate relationship between a focal plane and an imaging plane in the conventional technology according to an embodiment of the present disclosure;

FIG. 6 is a schematic diagram showing region division according to an embodiment of the present disclosure;

FIG. 7 is a schematic diagram showing dividing into four regions according to an embodiment of the present disclosure;

FIG. 8 is a schematic diagram showing a cause of a multipath problem according to the embodiment of the present disclosure;

FIG. 9 is a schematic diagram showing an emitting waveform in the conventional technology according to the embodiment of the present disclosure;

FIG. 10 is a schematic diagram showing an echo in a multipath scenario according to the embodiment of the present disclosure;

FIG. 11 is a schematic diagram showing echo comparison according to the embodiment of the present disclosure; and

FIG. 12 is a schematic flowchart of a detection method according to an embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those of ordinary skill in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

FIG. 1 is a schematic diagram showing functional modules of a detection device according to an embodiment of the present disclosure. As shown in FIG. 1, the detection device includes: a light emitting module 110, a processing module 120 and a light receiving module 130. The light emitting module 110 includes multiple emitting units, and the light receiving module 130 includes multiple receiving units corresponding to the light emitting module 110.

The processing module 120 is configured to generate a first instruction or an instruction different from the first instruction. The first instruction may be used to cause all the emitting units to simultaneously output emitted light. All the receiving units of the light receiving module 130 are in one-to-one correspondence with the emitting units. The processing module is configured to calculate distance data of a detected target according to data of the receiving module. The instruction different from the first instruction is used to cause the processing module 120 to be electrically connected to only some of the emitting units, so that the light emitting module 110 outputs the emitted light once or more than once. The light receiving module 130 is configured to acquire reflected light information of a target region once or more than once, and the processing module 120 is configured to acquire data of the receiving regions once or more than once. A result in the reflected light information of the target region that is obtained by the light receiving module 130 at least once does not contain multipath reflected light information, and the processing module 120 is configured to calculate target distance data that at least does not contain a part of the multipath reflected light information. For example, the processing module 120 generates a second instruction, and the processing module 120 is electrically connected to some of the light emitting units according to the second instruction. The light emitting module 110 outputs the emitted light once, the light receiving module 130 acquires the reflection information of the target region once, and the processing module 120 acquires the data once, and calculates and outputs the distance to the target. In this case, the detected target is relatively close, and only fewer emitting units are required to output the emitted light once, achieving low-power distance measurement. Alternatively, a part of the region is required to output the emitted light, which can achieve the effect of reducing or eliminating multipath interference (since the corresponding receiving region may only work partially, the effect of reducing or eliminating the multipath light can be obtained). In addition, the processing module 120 generates a third instruction, and the processing module 120 is electrically connected to some of the light emitting units according to the third instruction. The light emitting module 110 outputs the emitted light no less than twice, the light receiving module 130 acquires the reflection information of the target region two or more times, and the processing module 120 acquires the data no less than twice, and calculates and outputs the distance to the target. In this case, the receiving region receives the returned light information no less than twice correspondingly, so that the interference caused by the deflection of the returned light signal under the multipath interference can be eliminated.

The light emitting module 110 may be electrically connected to the processing module 120, and is configured to control, according to an emitting sequence instruction generated by the processing module 120, at least two emitting regions to sequentially output the emitted light. The light receiving module 130 may be electrically connected to the processing module 120, and is configured to control, according to the emitting sequence instruction generated by the processing module 120, at least two receiving regions to receive the reflected light of the emitted light for at least two times that is reflected from the detected target 150.

In the work process of the detection system, whether the processing module generates the first instruction or the instruction different from the first instruction may be determined based on distance information of the detected target. The distance information may be historical detection distance information. The historical distance information may be acquired by a process similar to adaptive pre-detection of the distance measurement process. That is, the detection device may electrically connect the processing module 120 with the light emitting module 110 according to the first instruction or the instruction different from the first instruction, and the light emitting module 110 outputs the emitted light once or more than once, and the processing module 120 acquires the data received by the light receiving device, calculates the historical detection distance information. Alternatively, the detection device is firstly activated in a predetermined manner according to a preset function table or similar empirical data, and the instruction of the detection system is adaptively adjusted in the actual detection process.

Further, as shown in FIG. 1, the detection device includes: the light emitting module 110, the processing module 120, and the light receiving module 130. The light emitting module 110 has at least two emitting regions, and the light receiving module 130 has at least two receiving regions corresponding to the light emitting module 110.

The processing module 120 is configured to generate the emitting sequence instruction. The emitting sequence instruction may be used to indicate an emitting sequence of the at least two emitting regions in the light emitting module 110, which may be sequential emission, random emission, and the like.

The light emitting module 110 may be electrically connected to the processing module 120, and is configured to control, according to an emitting sequence instruction generated by the processing module 120, the at least two emitting regions to sequentially output the emitted light. The light receiving module 130 may be electrically connected to the processing module 120, and is configured to control, according to the emitting sequence instruction generated by the processing module 120, the at least two receiving regions to receive the reflected light of the emitted light for at least two times that is reflected from the detected target 150. The operation herein is performed according to the third instruction.

The light emitting module 110 may include a light source and an optical emitting element. The light source includes but is not limited to a semiconductor laser and/or a solid-state laser, and may include other types of lasers. In a case that a semiconductor laser is used as the light source, a vertical-cavity surface-emitting laser VCSEL (Vertical-cavity surface-emitting laser) or an edge-emitting semiconductor laser EEL (edge-emitting laser) can be used, which is only exemplary and is not limited herein. Further, the waveform of the light outputted by the light source 110 is not limited herein, which may be a square wave, a triangular wave, a sine wave, or the like. In addition, the light source may be an LED or other light sources that can be pulsed. The optical emitting element includes but is not limited to a lens, a lens group, a Fresnel lens, a zone plate and/or a reflecting mirror, and the like. The emitted light outputted by the light source may be emitted to the detected target 150 via the optical emitting element. In the embodiments of the present disclosure, the light emitting module 110 includes the at least two emitting regions, which means that the light source is divided into regions to output the emitted light. The light receiving module 130 may include a receiving array and an optical receiving element. The receiving array includes but is not limited to a photodiode array, an avalanche photodiode array and a single-photon avalanche photodiode array, and the like, which may be realized by a unit having a photoelectric conversion function, such as a photo-diode (Photo-Diode, PD), which may be specifically a charge-coupled device (Charge-coupled Device, CCD), a complementary metal oxide semiconductor (Complementary Metal Oxide Semiconductor, CMOS), which is not limited herein. That is, the reflected light reflected from the detected target 150 may be received by the receiving array via the optical receiving element. In the embodiments of the present disclosure, the light receiving module 130 includes the at least two receiving regions, which means that the receiving array is divided into regions to receive the reflected light reflected from the detected target 150. The at least two receiving regions may be in one-to-one correspondence with the at least emitting regions based on the reflected light.

According to the division of the emitting regions, a region of the detected target 150 may be divided. Each emitting region may have a mapping relationship with one region on the detected target 150 and correspond to one receiving region. Optionally, the number of emitting regions may be the same as the number of receiving regions, that is, each emitting region corresponds to one receiving region, and the receiving region is used to receive the reflected light of the emitted light reflected from the detected target 150. In this way, the divisional emission of the light emitting module 110 and the divisional reception of the light receiving module 130 can be achieved, so that the energy originally occupying the entire field of view is concentrated on a smaller field of view to achieve energy concentration and improve power density. In addition, since the receiving regions correspond to the emitting regions, the returned light information breaks this correspondence due to the multipath interference, so that that the multipath interference cannot be received, thereby realizing the weakening or elimination of the multipath interference.

The processing module 120 is configured to sequentially acquire the data of the at least two receiving regions according to the emitting sequence instruction, and calculate the distance data of the detected target including the reflected light information for at least two times.

The light emitting module 110 controls the at least two emitting regions to sequentially output the emitted light according to the emitting sequence instruction generated by the processing module 120, and the light receiving module 130 controls the at least two receiving regions to receive the reflected light of the emitted light for at least two times reflected from the detected target 150 according to the emitting sequence instruction generated by the processing module 120. In this case, when receiving, the processing module 120 may sequentially acquire the data of the at least two receiving regions according to the emitting sequence instruction, and splice the data of the at least two receiving regions according to the emitting sequence instruction to synthesize a complete distance map, so that the distance data of the detected target including the reflected light information for at least two times can be calculated, and the detection distance for the detected target can be outputted, ensuring the detection accuracy while ensuring the detection distance, and avoiding the multipath interference.

In the case that the system operates according to the second instruction described above, the light emitting module 110 controls one of the emitting regions to output the emitted light according to the emitting sequence instruction generated by the processing module 120, and the light receiving module 130 controls one of the receiving regions to receive the reflected light of the emitted light reflected from the detected target 150 according to the emitting sequence instruction generated by the processing module 120. In this case, when receiving, the processing module 120 may sequentially acquire the data of the receiving region according to the emitting sequence instruction, and calculate the data of the receiving region according to the emitting sequence instruction to complete the distance map, so that the distance data of the detected target including the reflected light information for once can be calculated, and the detection distance for the detected target can be outputted, ensuring the detection accuracy while ensuring the detection distance, and the detection power can be reduced under the instruction without affecting the detection accuracy, thereby achieving the short-distance detection by self-adaptive adjustment of the detection system while the returned interference signal can be weakened.

The time-of-flight distance measurement device can confirm the execution of the first instruction or the instruction different from the first instruction according to the information in the scenario. For example, in a scenario where a target having a high reflectivity exists in the field of view, there is a relatively high probability that the target having the high reflectivity can reflect the detection light source. If the laser light of the light source is reflected by the target having the high reflectivity, a multipath interference problem may occur, which is explained in detail later. The first instruction is related to a distance to the detected target in the field of view, a reflectivity of the detected target in the field of view, historical detection distance information, or the like. The control instruction can be adaptively generated according to the specific conditions in the field of view, so as to obtain adaptation to the scenario in the field of view, and the influence of the multipath light can also be adaptively reduced or resolved.

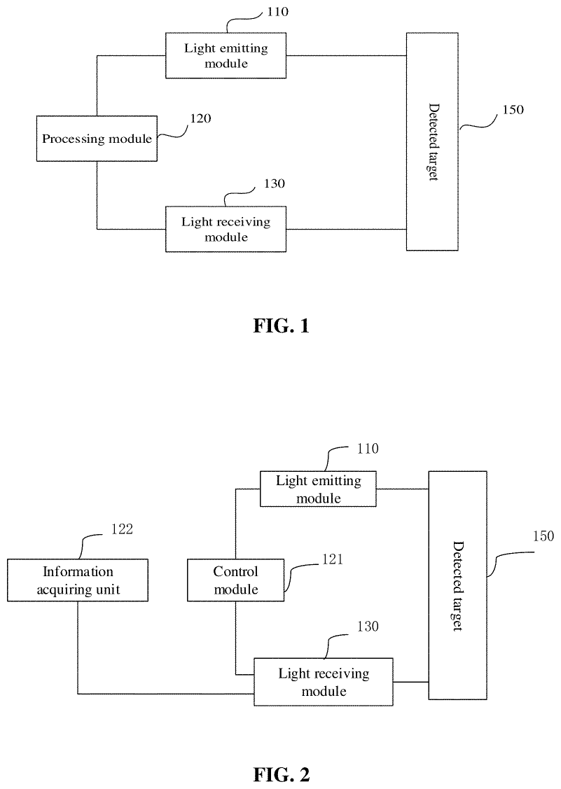

FIG. 2 is a schematic diagram showing functional modules for existing ITOF distance measurement according to an embodiment of the present disclosure. As shown in FIG. 2, the detection device includes: a light emitting module 110, a control module 121, a light receiving module 130 and an information acquiring unit 122. Similar to those shown in FIG. 1, the processing module may include the information acquiring unit 122 and the control module 121.

The control module 121 is configured to control the light emitting module 110 to emit the emitted light for different times. When the control module 121 has phase delays of 0°, 180°, 90° and 270° with the emitted light of the light emitting module 110, the light receiving module 130 acquires the light reflected by the detected target 150 corresponding to the different phase delays. The reflected light forms incident light in the light receiving module 130, and is photoelectrically converted into different information by the receiving module 130. In some cases, the 0° and 180° two-phase solution is also used to obtain the information of the detected target. In addition, the acquisition of the target information by the 0°, 120° and 240° three-phase solution is disclosed in some documents, and a five-phase delay solution is disclosed in even some documents, which is not specifically limited in the present disclosure. The acquired target information may be image information of the target, or distance information, contour information, and the like of the target, which is not specifically limited in the present disclosure. In order to illustrate the specific technical problems, the existing problems and solutions are described in detail by taking the four-phase time-of-flight distance acquisition solution as an example. The multi-tap structure may be a structure in which an independent tap is arranged for each phase. Four phase taps are connected to a pixel unit (may be directly connected or connected through an intermediate medium). Alternatively, two phases may share a tap, for example, 0° and 90° share a tap, 180° and 270° share a tap. With this design, not only reliable transmission of information can be achieved, but also the optimization of the pixel size design and layout structure can be ensured. The target information (such as the distance, depth, contour or image) can be efficiently obtained by connecting multiple taps to a pixel.

Based on the above, the light emitting module 110 emits the emitted light, and the light receiving module 130 is controlled by the control module 121 to obtain the light reflected from the detected target 150 with a predetermined phase delay, for example, four different phase delays from the emitted light. The reflected light forms incident light in the light receiving module 130. In this solution, no special requirements are made for the light source, and the light emitted by the light source is the same light each time and there is no phase difference, avoiding the error caused by the adjustment of the luminous state parameters of the light source device during use. Further, the realization of the device is relative simple, which ensures the reliability of the entire detection device system. In this solution, the phase delay is implemented in the light receiving module and the control module. The control module may be integrated in the light receiving module to ensure the simplicity and efficiency of the system structure. In addition, the multi-phase delay receiving solution is adopted in the light receiving module, avoiding the need to emit light for each phase at the emitting end. For example, in the four-phase solution, target information with two phase delays of 0° and 180° may be acquired by one emission, so that the entire ranging system can achieve the efficient distance measurement. The light emitted by the light emitting module 110 and reflected from the detected target 150 is converted into photo-generated electrons (or photo-generated charges) by a photoelectric conversion module in the light receiving module. Through the modulation by the taps, the photo-generated electrons or charges are transferred inside the device according to a first circuit or a second circuit (where the first circuit or the second circuit mentioned herein includes a charge or electron transfer channel inside the pixel). The photo-generated electrons or charges are respectively transmitted to different external physical circuits via a first electron transfer channel or a second electron transfer channel in the device (where the first circuit or the second circuit further includes a first physical circuit and a second physical circuit outside the pixel). Next, a physical operation (for example, using a charge storage unit, a capacitor, and the like) or a digital operation (for example, integrating a sensor and a computing unit into a chip) is performed in the pixel, or the physical operation or the digital operation is performed in a subsequent ADC circuit or other circuits, which is not limited in the present disclosure.

The following description is given by taking the four-phase two-tap structure as an example. For example, 0° and 90° share one tap, and 180° and 270° share one tap (in a actual operation, sharing a tap does not mean sharing a fixed tap, and the tap shared by the two phase delays may be exchanged with the other). The control module 121 controls the light emitting module 110 to emit the emitted light. After the light is reflected from the detected target 150, the control module 121 controls the light receiving module 130 to receive the light with two phase delays, for example, two phase delays of 0° and 180° in the above four-phase solution. The photoelectric conversion module in the light receiving module 130 converts the light signal with the phase delay into photo-generated electrons in the pixel. The tap of the first circuit receives a first modulation signal to transfer the photo-generated electrons of the 0° phase that are converted by the photoelectric conversion module in the pixel to form an electrical signal, which is outputted by the first circuit. Further, the tap of the second circuit receives a second modulation signal to transfer the photo-generated electrons of the 180° phase that are converted by the photoelectric conversion module in the pixel to form an electrical signal, which is outputted by the second circuit. Alternatively, each phase delay corresponds to one tap. In the first circuit, 0° and 90° share a floating diffusion node (FD), and 180° and 270° share a floating diffusion node (FD). In the actual operation, sharing a floating diffusion node does not mean sharing a fixed floating diffusion node, and the floating diffusion node shared by the two phase delays may be exchanged with the other. In this embodiment, the electrical signals respectively corresponding to the phase delays of 0° and 180° may be obtained in one light source emission. In a next control of the controller, the reception is performed for the two phase delays of 90° and 270° in the four-phase solution, and the photoelectric conversion module in the light receiving module 130 converts the light signal with the phase delay into photoelectric electrons in the pixel. The tap of the first circuit receives the first modulation signal to transfer the photo-generated electrons of the 90° phase that are converted by the photoelectric conversion module in the pixel to form an electrical signal, which is outputted by the first circuit. Further, the tap of the second circuit receives a second modulation signal to transfer the photo-generated electrons of the 270° phase that are converted by the photoelectric conversion module in the pixel to form an electrical signal, which is outputted by the second circuit. In this case, the information corresponding to 90° and 270° is obtained at one time. Further, the control module 121 may control the light emitting module 110 to output the emitted light, and control the reception for at least two phase delays of 0° and 180° in the four-phase solution. The photoelectric conversion module in the light receiving module 130 converts the light signal with the phase delay into photoelectric electrons in the pixel. The tap of the first circuit receives the first modulation signal to transfer the photo-generated electrons of the 180° phase that are converted by the photoelectric conversion module in the pixel to form an electrical signal, which is outputted by the first circuit. Further, the tap of the second circuit receives a second modulation signal to transfer the photo-generated electrons of the 0° phase that are converted by the photoelectric conversion module in the pixel to form an electrical signal, which is outputted by the second circuit. In this way, at least one electrical signal corresponding to the same-phase received control signal is obtained by the two circuits. In the final target information operation process, the at least two electrical signals obtained by the two circuits may be operated to obtain target information. For example, for image or distance information, the following operations may be performed using the signals obtained by the two circuits.

f(0°)=mf(0°_1)+nf(0°_2);

f(180°)=1f(180°_1)+hf(180°_2); (1)

The results of the phase delays of 90° and 270° are obtained similarly, and may be corrected by an operation similar to the formula 1. The corrected result may be used to obtain the final target information. The corrected result may be an intermediate result and may be directly used in a specific expression of the final image or distance operation, which is not limited in the present disclosure. In the above formula, f(0°) represents a final information result corresponding to the 0° phase that needs to be corrected, f(0°_1) represents an information result corresponding to the 0° phase obtained by the first circuit, and f(0°_2) represents an information result corresponding to the 0° phase obtained by the second circuit, where m, n, l, h each may be a correction coefficient valued in an interval [−1, 1].

In the above embodiment, the receiving phases whose phase delays are respectively 0° and 180° have a phase difference of 180°, the modulation signals corresponding to the first circuit and the second circuit for the two delayed receiving phases are reciprocal signals. That is, in a first time period, the first circuit or the second circuit outputs the electrical signal for the reception of the 0° phase delay, and neither the first circuit nor the second circuit outputs the electrical signal for the reception of the corresponding 180° delay on the pixel, and in another time period, the opposite operation is performed. The similar operation is performed for the receiving phases having a phase difference of 180° whose phase delays are respectively 90° and 270°. In this way, the circuit modulation signals corresponding to the receiving phases having a phase difference of 180° are reciprocal signals, achieving the effect of signal reliability acquisition and system efficient operation while multiple phases share a tap or floating diffusion (FD) node or other circuit components. Phase information with a phase difference of 90° is acquired at a first time interval. This time interval is a self-adjusting time interval inside the system, which may be designed according to a reset sequence to ensure the reliability of the output of different phase signals.

In a case that the charges are distributed to the first tap and the second tap according to the distance to the target, the depth representing the distance to the target may be calculated by using all eight detections signals (for each phase signal, the electrical signals corresponding to the phase delay are obtained by two circuits). Electrical information of different phases may be outputted by two different circuits, such as the accumulated charge amount signal. In the process of distance acquisition, a phase difference Φ of the light signal shuttling between a lidar imaging radar and the target may be calculated based on 4 groups of integral charges. Taking sinusoidal modulated light as an example, the phase difference Φ between the echo signal corresponding to the modulated light and the emitted signal is expressed as:

Φ=arctan [(Q90°−Q270°)/(Q0°−Q180°)] (2)

In the above formula 2, Q0°, Q90°, Q180° and Q270° respectively represent electrical signals converted by the receiver circuits corresponding to different phase delays. In combination with the relationship between the distance and the phase difference, the final distance result may be obtained.

d=(c/2)*[1/(2πf)]*Φ (3)

In the above formula 3, c represents the speed of light, and f represents the frequency of the laser light emitted by the light source 110. If the light emitted by the light source 110 is a square wave, the following different cases exist, and the final distance information is obtained according to the following calculation method.

In the case of Q0°>Q180° and Q90°>Q270°,

$${D}_{c} = \frac{c}{2} * \frac{1}{4 f} * ( \frac{{Q}_{90 °} - {Q}_{270 °}}{( {Q}_{0 ° -} {Q}_{180 °} ) + ( {Q}_{90 ° -} {Q}_{270 °} )} ) \qquad ( 4 )$$

In the case of Q0°<Q180° and Q90°>Q270°,

$${D}_{c} = \frac{c}{2} * \frac{1}{4 f} * ( 2 - \frac{{Q}_{90 °} - {Q}_{270 °}}{( {Q}_{90 °} - {Q}_{270 °} ) - ( {Q}_{0 °} - {Q}_{180 °} )} ) \qquad ( 5 )$$

In the case of Q0°<Q180° and Q90°<Q270°,

$${D}_{c} = \frac{c}{{\text{?}}_{f}} * ( 2 + \frac{{Q}_{90 °} - {Q}_{270 °}}{( {Q}_{90 °} - {Q}_{270 °} ) + ( {Q}_{0 ° -} {Q}_{180 °} )} ) \qquad ( 6 )$$

$$\text{?} \text{indicates text missing or illegible when filed}$$

In the case of Q0°>Q180° and Q90°<Q270°,

$${D}_{c} = \frac{c}{{\text{?}}_{f}} * ( 4 - \frac{{Q}_{90 °} - {Q}_{270 °}}{( {Q}_{90 °} {Q}_{270 °} ) - ( {Q}_{0 °} {Q}_{180 °} )} ) \qquad ( 7 )$$

$$\text{?} \text{indicates text missing or illegible when filed}$$

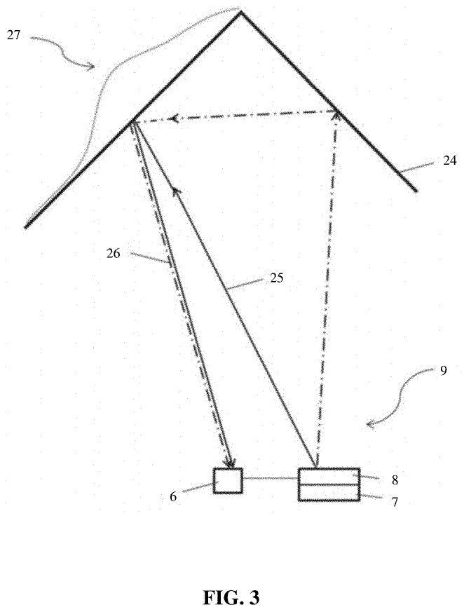

FIG. 3 is a schematic diagram showing a multipath scenario in the time-of-flight distance measurement in the conventional technology. FIG. 3 shows a conventional TOF detection system 9. The system includes a lighting unit 8, a TOF sensor 6, and a processing device 7. The lighting unit 8 is configured to illuminate a scene 24 in multiple directions. The TOF sensor 6 is configured to detect reflection of the emitted light. The processing device 7 is configured to process the data obtained by the TOF sensor 6.

A pixel (not shown) of the TOF sensor 6 is used to measure a direct path 25 from the lighting unit 8 to the scene 24 and then from the scene 24 back to the pixel. However, a secondary reflection 26 or a higher order reflection may be captured on the same pixel, which disrupts the perceived delay of the first direct reflection 25. The light captured by the sensor 6 may originate from both the direct path 25 and the secondary reflection 26, and in this case the measured depth map 27 (representing the depth associated with each point of the scene) is erroneous.

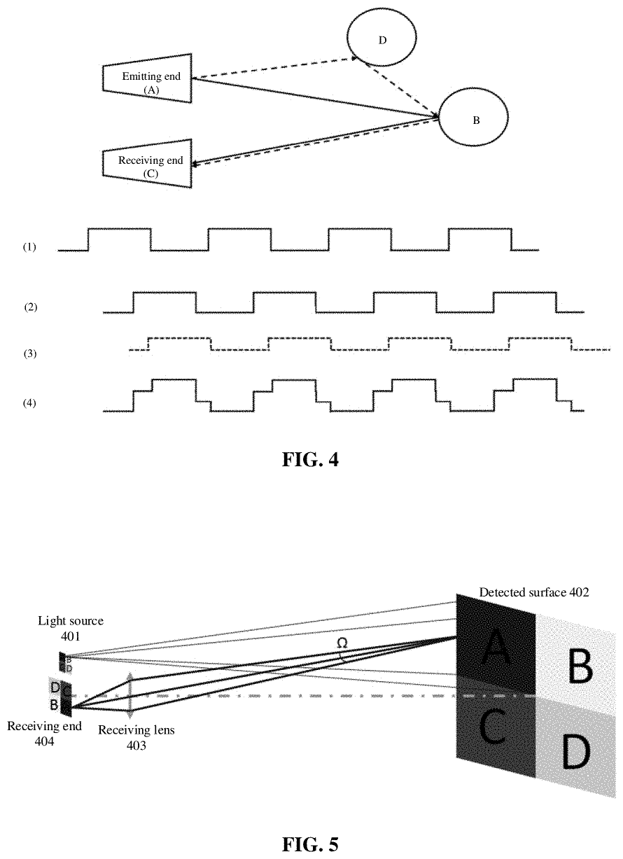

FIG. 4 is a schematic diagram showing an influence of the multipath on measurement accuracy in the conventional technology according to an embodiment of the present disclosure. As shown in FIG. 4, a waveform (1) is a light source waveform emitted by an emitting end (A), where the emitting end (A) transmits the light source waveform (1) to a to-be-detected target B. The to-be-detected target B reflects the received light to a receiving end (C). In accordance with a principle the same as that shown in FIG. 3, the distance to the to-be-detected target B may be obtained according to the waveform reflected from the to-be-detected target B, which is not repeated herein. However, in the multipath scenario, the light source waveform (1) emitted by the emitting end (A) may be firstly received by a target D near the to-be-detected target B and then is reflected to the to-be-detected target B. After being reflected twice by the to-be-detected target, the light reaches the receiving end C. The multipath secondary reflected light is shown as a waveform (3) in FIG. 4. An echo signal finally received by the receiving end (C) is a mutual effect of the waveform (2) and the waveform (3).

In this case, since there is one more reflection in the motion path of the multipath light (3) and the optical path is increased by a certain distance, a segment of the echo signal having weaker intensity and relatively later time sequence is generated at the received signal end. In the test performed by the integration method, certain interference is generated for the amount of charges obtained by different integrals, which interferes with the actual distance measurement result and affects the accuracy of the distance measurement.

FIG. 5 is a schematic diagram showing a conjugate relationship between a focal plane and an imaging plane in the conventional technology according to an embodiment of the present disclosure. As shown in FIG. 5, a light source 401 is divided into four sub-regions A, B, C, and D to emit light, and the emitted light of each sub-region is projected onto a detected surface 402. The light projected onto the detected surface 402 undergoes diffuse reflection, and the light entering the field of view of the lens 403 is received by a receiving lens 403, thereby forming an image on a receiving end 404. Imaging ranges of the sub-regions A, B, C, and D on the receiving end 404 respectively correspond to target ranges of sub-regions A, B, C, and D of the detected surface 402. For example, all target points on the sub-region A of the detector enters the field of view of the receiving lens and is imaged on the receiving end, and each target point corresponds to one imaging point on the sub-region A of the receiving end. Among lights scattered by each target point, only the light in the solid angle range Ω as shown in FIG. 5 can enter the receiving lens.

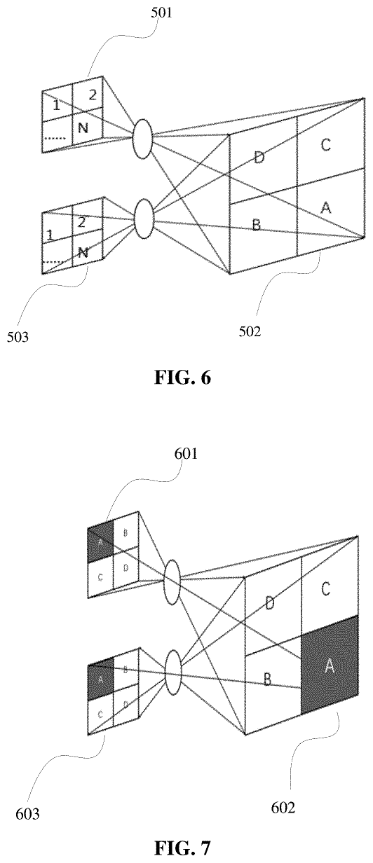

FIG. 6 is a schematic diagram showing region division according to an embodiment of the present disclosure. Since the multipath shown in FIG. 4 affects the accuracy of the distance measurement, the influence of the multipath should be eliminated in the actual detection process. As shown in FIG. 6, an emitting end 501 and a receiving end 505 are modulated for transmission and reception by the region division. As shown in FIG. 6, the emitting end is divided into N regions, which are respectively marked as regions 1, 2, 3, . . . , N. Further, the receiving end is divided into N regions, which are respectively marked as regions 1, 2, 3, . . . , N. According to the principle of focal plane imaging as shown in FIG. 5, the N regions of the emitting end are in an optical conjugate relationship with the N regions of the receiving end, that is, in one-to-one correspondence. When the region 1 of the emitting end 501 emits light, the reflected light from the to-be-detected target is received in the corresponding receiving region 1 in the receiving region 503 after the reflection of the to-be-detected target 502 without considering the influence of the multipath, and the reflected light received by other non-corresponding regions is considered to be under the influence of the multipath. In this way, the multipath light can be identified in the reflected light received by the receiving end 503, so as to eliminate the multipath light, and thus the distance to the to-be-detected target can be obtained according to the distance measurement principle shown in FIG. 2. In the actual distance measurement process, the receiving region that does not correspond to the emitting region may not be opened, and the multipath reflected light may not be received. The processing module further includes an information acquiring unit. The information acquiring unit according to the reflected light information that does not contain at least a part of the multipath and that is outputted by the receiving module in at least a part of the time period. In the case of the instruction different from the first instruction, the light emitting module outputs the emitted light more than once, the light receiving module acquires the reflected light information of the target region more than once, and the processing module synthesizes all information of a detected field of view according to the reflected light information of the target region acquired by the light receiving module more than once, so as to obtain the information in the detected field of view after weakening or eliminating the multipath interference.

Optionally, in the actual distance measurement process, only M regions simultaneously emit the modulated waveforms each time, and the M regions are not adjacent to each other as much as possible. When the M regions start to emit the modulated light signal, only the regions corresponding to the M regions at the receiving end are opened to receive the reflected light generated by the target. After the reflected light received by the M regions is obtained, the distance to the to-be-detected target is obtained according to the distance measurement principle shown in FIG. 1 or FIG. 2. In this way, the influence of the multipath is eliminated, so that the multipath effect generated in the ITOF distance measurement process can be significantly reduced, and the distance measurement accuracy can be improved.

FIG. 7 is a schematic diagram showing dividing into four regions according to an embodiment of the present disclosure. As shown in FIG. 7, both an emitting end 601 and a receiving end 603 are divided into four parts for the divisional emission and the divisional reception, and only one region is opened at a time. As shown in FIG. 7, a region A is opened at the emitting end, and the light source in the region A reaches a corresponding region A of the receiving end 603 after being reflected from the to-be-detected target 602. In this embodiment, only the receiving region A is opened. Further, receiving regions B, C, and D may be opened, but the reflected light received by the receiving regions B, C, and D is regarded as the multipath light. It should be noted that the region divided by the to-be-detected target 602 is only for illustration, and there is no one-to-one correspondence with the emitting region and the receiving region, which is not limited herein.

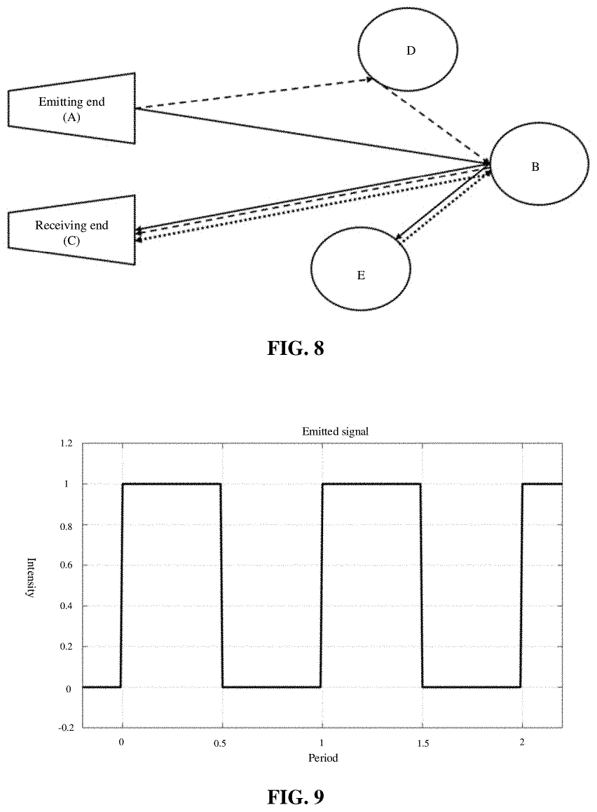

FIG. 8 is a schematic diagram showing a cause of a multipath problem according to the embodiment. As shown in FIG. 8, an emitting end (A) emits light to a to-be-detected target B, and the light reaches a receiving end (C) after being reflected from the to-be-detected target. There are a multipath target D and a multipath target E near the to-be-detected target. As shown in FIG. 8, there are three possible paths in the multipath scenario, which respectively are a path 1, a path 2 and a path 3. In the path 1, the emitting end (A) emits the light to the to-be-detected target B, and the reflected light from the to-be-detected target B reaches the receiving end (C). In the path 2, the emitting end (A) emits the light to the multipath target D, the multipath target reflects the light to the to-be-detected target B, and the to-be-detected target reflects the multipath light to the receiving end (C). In the path 3, the emitting end (A) emits the light the to-be-detected target B, the to-be-detected target B reflects the emitted light to reach the multipath target E, the multipath target E secondarily reflects the light to reach the to-be-detected target B, and the to-be-detected target B reflects the light again to reach the receiving end (C). In the actual use, the multipath effect in the distance acquisition system may be preset in the detection device, which may be obtained, for example, by a fixed function, in a table form, or by adaptively acquiring the characteristics of the target in the field of view. A judgment result for the multipath effect associated with the detected target in the field of view is obtained, different regions and light sources are controlled according to this information, so as to adaptively obtain the effect of reducing or eliminating the multipath interference to obtain the more accurate detection result.

FIG. 9 is a schematic diagram showing an emitting waveform in the conventional technology provided in this embodiment.

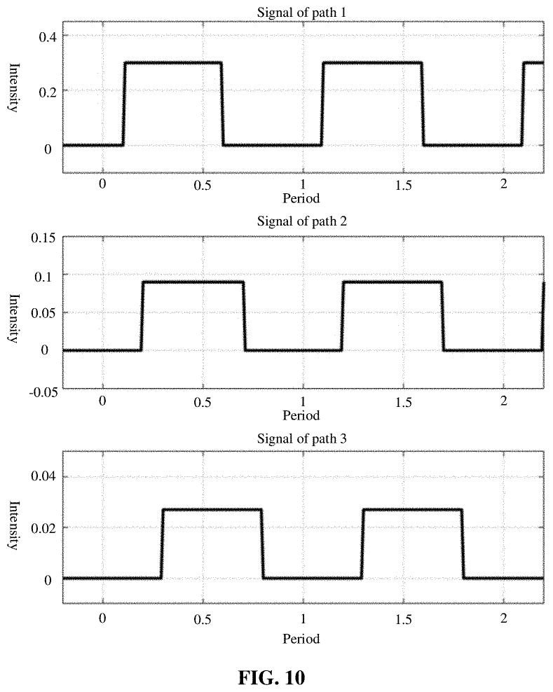

FIG. 10 is a schematic diagram showing an echo in a multipath scenario provided in this embodiment. The echo signals shown in FIG. 10 are obtained in the multipath scenario shown in FIG. 8. In the multipath scenario shown in FIG. 8, it is assumed that the reflectivity of the reflective target B, the multipath target D, and the multipath target E is all 30%. The echo signals of the three paths are shown in FIG. 10. It can be seen from FIG. 10 that the echo signal of the path 3 is relative weak due to the multiple reflections, which has little effect on the accuracy of distance measurement.

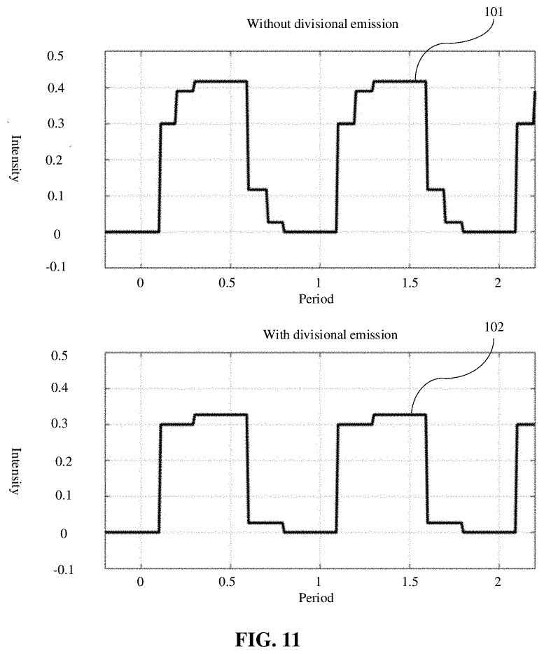

FIG. 11 is a schematic diagram showing echo comparison provided in this embodiment. In the case of the divisional emission as shown in FIG. 6, since the multipath target D cannot directly receive the light emitted from the emitting end (A), the path 2 shown in FIG. 8 does not exist, and only the path 1 and the path 3 exist. As shown in FIG. 10, an echo signal 101 is received in the case of no divisional emission, and the echo signal 102 is received in the case of the divisional emission. It can be seen that, in the case of the divisional emission, the waveform of the echo signal is closer to the real waveform, so that the distance measurement result is more accurate.

In the actual use, it is not limited to weakening the effect in the ITOF, but also in a DTOF measurement system. In the case that the multipath interference exists, the triggering probability of the avalanche diode in the detector array is increased, and second peak information different from a peak corresponding to the actual distance measurement result may exist. In this case, more complex processing is required in the DTOF measurement to obtain the most accurate measurement result. Further, less multipath interference can be obtained with this solution, thus reducing the complexity of the post-processing circuit, which is not described in detail herein.

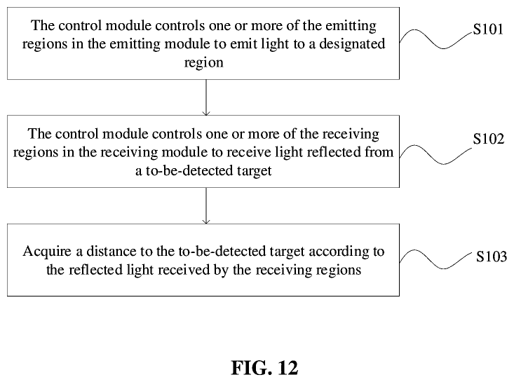

FIG. 12 is a schematic flowchart of a detection method according to an embodiment of the present disclosure. This method may be applied to the detection device described above, and the basic principle and technical effects of the method are the same as those of the corresponding sensor embodiments. For a brief description, the parts not mentioned in this embodiment can be referred to the corresponding content in the sensor embodiments. As shown in FIG. 12, the detection method includes the following steps S101 to S103.

In S101, the control module controls one or more of the emitting regions in the emitting module to emit light to a designated region.

In S102, the control module controls one or more of the receiving regions in the receiving module to receive light reflected from a to-be-detected target.

In S103, a distance to the to-be-detected target is acquired according to the reflected light received by the receiving regions.

Optionally, the multiple emitting regions are in one-to-one correspondence with the multiple receiving regions.

Optionally, the control module controls a receiving region among the receiving regions corresponding to the one or more emitting regions emitting the light source to the designated region to receive the reflected light.

Optionally, the emitting region has a conjugate relationship with the corresponding receiving region.

Optionally, the receiving regions include a region that receives the reflected light from the to-be-detected target and/or a region that receives the multipath reflected light.

Optionally, the control module is electrically connected to the emitting module, and controls the emitting region to emit the light to a designated region.

Optionally, the control module is electrically connected to the receiving module, and controls the receiving region that does not have a corresponding relationship with the emitting region to receive multipath light.

Optionally, the control module is electrically connected to the receiving module, and controls the receiving region that does not have a corresponding relationship with the emitting region to not receive the reflected light.

The above method is applied to the detection device provided in the above embodiments, and the implementation principle and technical effect thereof are similar, which are not repeated herein.

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A time-of-flight distance measurement device, comprising: a light emitting module, a processing module and a light receiving module, the light emitting module having at least two emitting regions, the light receiving module having at least two receiving regions corresponding to the light emitting module, wherein
the processing module is configured to generate a first instruction to be electrically connected to all emitting units so that all the emitting units simultaneously output emitted light, wherein receiving units of the light receiving module are in one-to-one correspondence with the emitting units, and the processing module is configured to calculate distance data of a detected target according to data of the light receiving module, and
the processing module is further configured to generate an instruction different from the first instruction, so that the light emitting module outputs the emitted light once or more than once, wherein the light receiving module acquires reflected light information of a target region once or more than once, and a result in the reflected light information of the target region that is obtained by the light receiving module at least once does not contain multipath reflected light information, and the processing module is configured to calculate target distance data that at least does not contain a part of the multipath reflected light information.

2. The time-of-flight distance measurement device according to claim 1, wherein the first instruction is related to a distance to the detected target in a field of view, a reflectivity of the detected target in the field of view, historical detection distance information, or the like.

3. The time-of-flight distance measurement device according to claim 1, wherein the processing module further comprises:
a control module configured to control the receiving region corresponding to the emitting region to receive the reflected light.

4. The time-of-flight distance measurement device according to claim 1, wherein the at least two emitting regions are in one-to-one correspondence with the at least two receiving regions.

5. The time-of-flight distance measurement device according to claim 3, wherein the control module is configured to control one or more of the emitting regions to emit light to a designated region.

6. The time-of-flight distance measurement device according to claim 5, wherein the control module is configured to control a receiving region among the receiving regions corresponding to the one or more emitting regions emitting the light to the designated region to receive the reflected light.

7. The time-of-flight distance measurement device according to claim 1, wherein the emitting region has a conjugate relationship with the corresponding receiving region.

8. The time-of-flight distance measurement device according to claim 1, wherein the receiving regions comprise a region that receives the reflected light from a to-be-detected target and/or a region that receives the multipath reflected light.

9. The time-of-flight distance measurement device according to claim 3, wherein the control module is electrically connected to the emitting module and is configured to control the emitting region to emit light to a designated region.

10. The time-of-flight distance measurement device according to claim 3, wherein the control module is electrically connected to the receiving module and is configured to control the receiving region that does not have a corresponding relationship with the emitting region to receive multipath light.

11. The time-of-flight distance measurement device according to claim 3, wherein the control module is electrically connected to the receiving module and is configured to control the receiving region that does not have a corresponding relationship with the emitting region to not receive the reflected light.

12. The time-of-flight distance measurement device according to claim 1, wherein the processing module further comprises:
an information acquiring unit configured to: according to the reflected light information that does not contain at least a part of the multipath and that is outputted by the receiving module in at least a part of the time period.

13. The time-of-flight distance measurement device according to claim 1, wherein in the case of the instruction different from the first instruction, the light emitting module outputs the emitted light more than once, the light receiving module acquires the reflected light information of the target region more than once, and the processing module synthesizes all information of a detected field of view according to the reflected light information of the target region acquired by the light receiving module more than once.

14. A time-of-flight distance measurement method, comprising: a light emitting module, a processing module and a light receiving module, the light emitting module having at least two emitting regions, the light receiving module having at least two receiving regions corresponding to the light emitting module, wherein
the processing module is capable of generating a first instruction to be electrically connected to all emitting units so that all the emitting units simultaneously output emitted light, wherein receiving units of the light receiving module are in one-to-one correspondence with the emitting units, and the processing module calculates distance data of a detected target according to data of the light receiving module, and
the processing module is further capable of generating an instruction different from the first instruction, so that the light emitting module outputs the emitted light once or more than once, wherein the light receiving module acquires reflected light information of a target region once or more than once, and a result in the reflected light information of the target region that is obtained by the light receiving module at least once does not contain multipath reflected light information, and the processing module is configured to calculate target distance data that at least does not contain a part of the multipath reflected light information.

15. The time-of-flight distance measurement method according to claim 14, wherein the first instruction is related to a distance to the detected target in a field of view, a reflectivity of the detected target in the field of view, historical detection distance information, or the like.

16. The time-of-flight distance measurement method according to claim 14, wherein the processing module further comprises:
a control module configured to control the receiving region corresponding to the emitting region to receive the reflected light.

17. The time-of-flight distance measurement method according to claim 14, wherein the at least two emitting regions are in one-to-one correspondence with the at least two receiving regions.

18. The time-of-flight distance measurement method according to claim 16, wherein the control module controls one or more of the emitting regions to emit light to a designated region, and the control module controls a receiving region among the receiving regions corresponding to the one or more emitting regions emitting the light to the designated region to receive the reflected light.

19. The time-of-flight distance measurement method according to claim 14, wherein the receiving regions comprise a region that receives the reflected light from a to-be-detected target and/or a region that receives the multipath reflected light.

20. The time-of-flight distance measurement method according to claim 16, wherein the control module is electrically connected to the receiving module and controls the receiving region that does not have a corresponding relationship with the emitting region to receive multipath light.
